(19) United States
(12) Patent Application Publication
(10) Pub. No.: US 2016/0307186 A1
(43) Pub. Date: Oct. 20, 2016

(54) VERIFICATION OF CONTACTLESS PAYMENT CARD FOR PROVISIONING OF PAYMENT CREDENTIALS TO MOBILE DEVICE

(71) Applicant: MasterCard International Incorporated, Purchase, NY (US)

(72) Inventors: James Christian Noë, West Wickham (GB); John Tierney, Merseyside (GB)

(21) Appl. No.: 14/691,052

(22) Filed: Apr. 20, 2015

(51) Int. Cl. G06Q 20/32; G06Q 20/36; G06Q 20/20; G06Q 20/34

(52) U.S. Cl. CPC G06Q 20/3278; G06Q 20/341; G06Q 20/352; G06Q 20/3672; G06Q 20/204; G06Q 2220/00

(57) ABSTRACT

A communication channel is established between a mobile device and a remote payment support service computer. The mobile device exchanges data communications with a contactless IC (integrated circuit) payment device, and triggers the payment device to generate a cryptogram. The mobile device receives the cryptogram and transmits it to the remote payment support service computer. The mobile device receives provisioning of payment credentials from the remote payment support service computer.

### BACKGROUND

Payment accounts are in widespread use. At a point of sale, such accounts may be used for purchase transactions, and may be accessed by devices such as magnetic stripe cards, contactless or contact integrated circuit (IC) cards (also sometimes referred to as “smartcards”, or EMV cards (cards operating in accordance with the well-known EMV standard)), or payment-enabled mobile devices, such as payment-enabled smartphones, smart watches, wristbands, tags/stickers, etc. In the case of a payment-enabled mobile device, it may emulate a contactless payment card by engaging in an exchange of communications with a point of sale (POS) terminal

In some mobile implementations, a method called “Tokenization” is used. This is an approach whereby the payment credentials (such as the Primary Account Number (PAN)) stored on the device are distinctly different from the payment credentials visible to the account holder. A third party service provider may act as a “Token Vault”, with responsibility for generating token data, mapping token data to the original (e.g., PAN) data, and any cryptographic functions relating to the token data. Tokens are designed to look and act like normal cards when presented to terminals. (Various aspects and use-cases relating to tokenization practices are described in the “Payment Token Interoperability Standard” (the “Tokenization Standard”) published in November 2013 by MasterCard International Incorporated (which is the assignee hereof), Visa and American Express.)

The exchange of communications at the point of sale, in a mobile-device-as-payment-device implementation, may include transmission of a payment account indicator—PAN (“primary account number”) or payment token—from the payment-enabled mobile device to the POS terminal The POS terminal may then generate a transaction authorization request message, including the payment account indicator, and the transaction authorization request message may then be routed (with de-tokenization if necessary) for approval by the payment account issuer.

According to a process called “provisioning”, payment account credentials may be downloaded from a central computer to a mobile device so that the mobile device is enabled to provide the above-mentioned payment function. According to some proposals, provisioning may occur via communications over-the-air to the mobile device. As part of the provisioning/set-up process, according to some proposals, the user may manually enter, into the mobile device, the PAN displayed on the user's payment card that is now to be emulated by the mobile device. However, the manual entry of the account number may not be a very convenient operation from the user's point of view, and may be prone to errors in entering the digits of the account number. Furthermore, this approach does not guarantee that the user is in possession of the authentic payment card, for the user may have wrongfully obtained a fraudulent PAN or may be reading the PAN from a counterfeit payment card. Also, cards issued by some payment account issuers may not have the PAN or token and/or expiration data and/or security code printed or embossed on the card, in which case the user would not know the credentials details.

According to another proposal, the camera on the mobile device may be used to capture an image of the PAN on the payment card, in order to input the PAN into the mobile device. While this may be faster and more convenient than manually entering the PAN digit by digit, the risk remains for the account issuer that the image captured is from a counterfeit card, or from a counterfeit image of a card, and does not solve the issue where one or more of the required elements is not present on the card.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram that illustrates a system for provisioning payment credentials to a mobile device in accordance with aspects of the present invention.

FIG. 2 a payment-enabled mobile device provided in accordance with aspects of the present invention and that may be used in connection with the system of FIG. 1.

FIG. 3 is a block diagram that illustrates a computer system that may be operated as part of the system of FIG. 1 and in accordance with aspects of the present invention.

FIG. 4 is a flow chart that illustrates a process that may be performed in the system of FIG. 1 in accordance with aspects of the present invention.

FIG. 5 is a flow chart that illustrates details of the process of FIG. 4.

### DETAILED DESCRIPTION

Today, some mobile payment systems implement a system known as “Tokenization”. This system works in the following way:
A card issuer registers and configures themselves with a tokenization service. These services are often provided by card schemes such as MasterCard, or may be provided by other suitable third party processors.
End users can then register their card details—this is done by them opening up a ‘wallet application’ on the device and entering their card details, either manually typing in the PAN, cardholder name, expiry and card security code (e.g., CVC2) (or combination of these), or by using the device's camera to automatically capture and enter these details.
The details are then sent from the device, to the wallet service provider and through to the tokenization service.
The tokenization service checks that the details are originating from a card that is registered for the service, if so, it passes the details on to the card issuer.
The card issuer then makes a decision on whether or not to allow tokenization, refuse tokenization, or require further user authentication (in which case other steps are taken to authenticate the user such as a call to the call centre, SMS verification, mobile or internet banking authentication etc.).
Once approved and authenticated the tokenization service generates a set of token credentials which may include a token card number, token expiration date and token payment parameters (such as currency code, country codes, issuer action codes etc . . . ) which can then be provisioned onto the phone (note that it is also possible to create the token and load it to the phone whilst authentication takes place—the token will only become active once the user is fully authenticated).

During a transaction, the following steps occur:
Contactless
The user taps their phone against a contactless terminal in store in order to make payment.
The user may be prompted to authenticate themselves to the device (e.g. with a PIN or biometric).
The transaction is sent off to the merchant's acquirer who in turn sends it to the card scheme.
If the card scheme (or card issuer) knows that the transaction was undertaken with a token it will:
Check the cryptography if EMV data is present.
Check any dynamic values (such as a dynamic security code) for contactless magnetic stripe transactions.
Perform other processing checks as required.
Translate the token details to the real card details.
Make any other scheme specific data element changes.
Send the transaction to the card issuer.
The card issuer will then perform their normal authorization, or may perform additional logic as they know the transaction was performed with a token
The card issuer will then send the response to the card scheme, who in turn perform an inverse translation back to the token PAN and send the data back to the acquirer and then the merchant.
In App
Similar to contactless, but the transactions will be initiated from within a merchant's application.

One key issue with the above embodiment of creating the initial token is it fundamentally relies on the user knowing all (or enough) of the card details. Not all card issuers make all of these details available to their customers; for example in the Netherlands it is common practice not to print or emboss the PAN on the card. Without these details, it makes registering the card with the processes today impossible, and large groups of users would be precluded from using these services. Furthermore, manually entering card details can be error prone and open to fraud.

In general, and for the purpose of introducing concepts of embodiments of the present invention, a mobile device such as a smartphone may be programmed to emulate an EMV terminal so as to be able to interact with a contactless payment card, and the mobile device also may be programmed to have capabilities for providing payment credentials at a point of sale. In a process to facilitate provisioning of payment credentials to the mobile device, an interaction may occur between the mobile device and a contactless payment card that is to be “digitized” into the mobile device (i.e., to have corresponding payment credentials provisioned to the mobile device). As part of the interaction with the mobile device, the contactless payment card may generate a cryptogram that it transmits to the mobile device. For example, the mobile device may be programmed to emulate a contactless card reading terminal, and the interaction with the contactless payment card may be a zero-amount payment card transaction. A skilled artisan would be familiar with the types of EMV “Application Cryptograms” that could be used in this instance (TC, ARQC or AAC), likewise they would be familiar with other uses of dynamic data such as dCVC3 in order to verify a certain card was used.

The mobile device may transmit the cryptogram generated (along with any other relevant data including (but not limited to) the PAN, expiration date, PAN sequence number etc.) by the contactless payment card to a remote payment support service computer. This may occur directly or via a wallet service provider with which the user of the mobile device is enrolled. The remote payment support service computer may transmit the cryptogram to the account issuer associated with the payment credentials that are to be provisioned. The account issuer may verify the cryptogram, and then consent to the provisioning of the payment credentials. The very presence of a valid cryptogram indicates with a high degree of likelihood that the card was present. The remote payment support service computer, or suitable trusted third party, may then provision the payment credentials to the mobile device. Alternatively, in some embodiments, a secure application in the mobile device may perform card authentication.

With this approach, there is a high degree of assurance that the card/account information being digitized/provisioned into the mobile device is based on the user's possession of a valid contactless payment card. Moreover, the automatic reading of the contactless payment card by the mobile device may make the provisioning process highly convenient for the user. However, presence of the card alone may not be sufficient for digitization to be completed, and the account issuer may (at their discretion, or as required by local laws, scheme rules or wallet service provider rules) require additional identification and verification (ID&V) of the consumer attempting to digitize the card. This prevents a newly stolen card from being digitized onto a device.

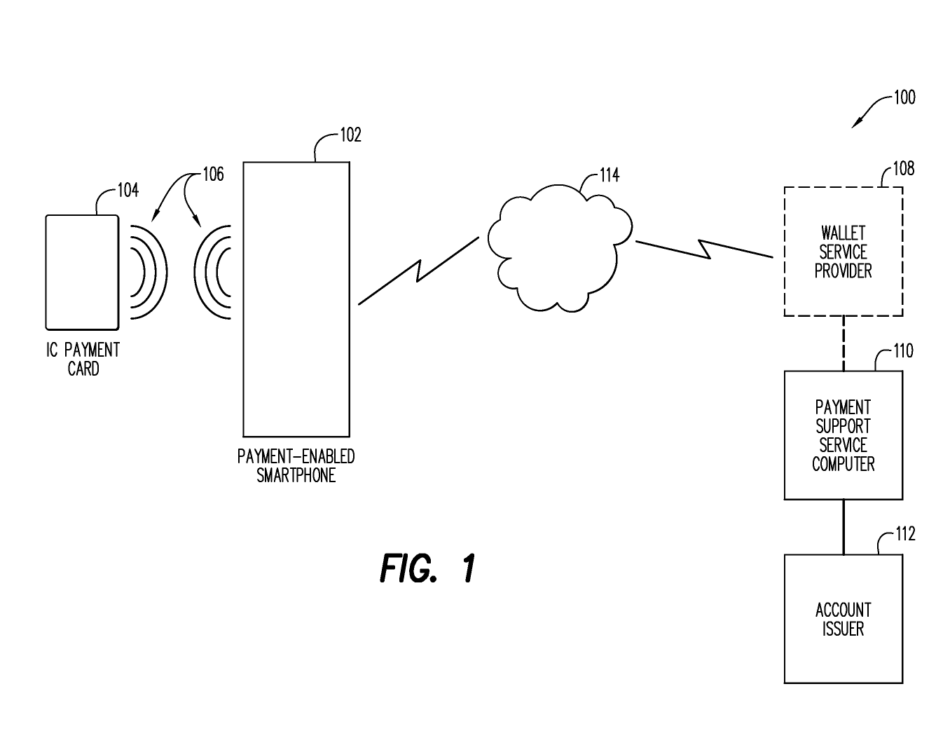

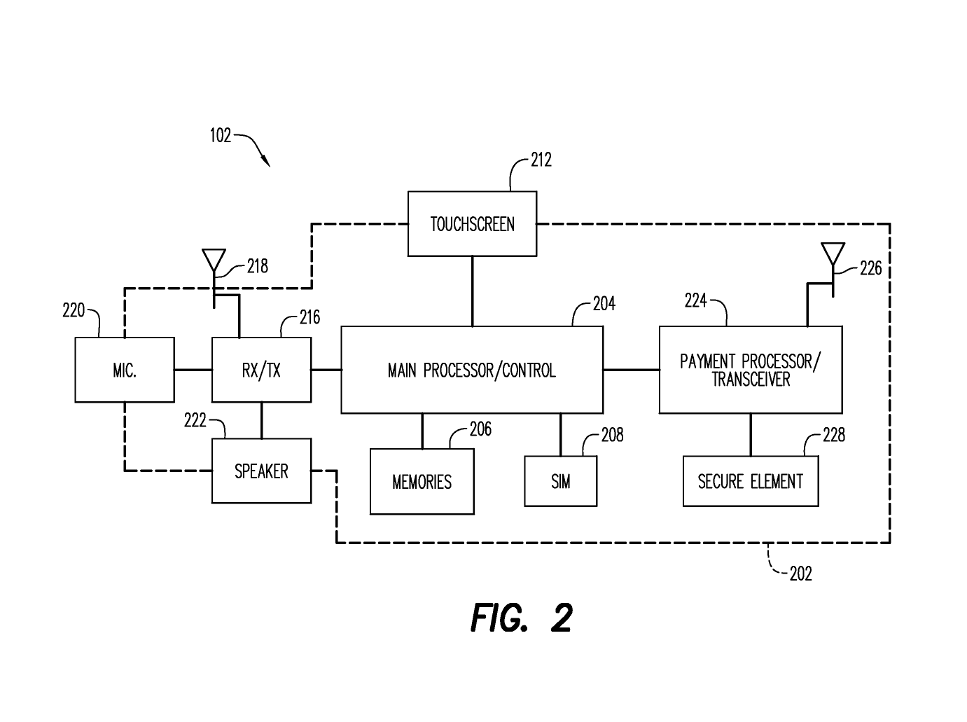

FIG. 1 is a block diagram that illustrates a system 100 provided in accordance with aspects of the present invention. The system 100 facilitates provisioning of payment credentials to a mobile device 102. For purposes of illustration, the mobile device 102 is assumed to be a payment-enabled smartphone, but it could be any suitable device such as a tablet computer, a smart watch, a personal computer, etc. Details of the mobile device 102 will be described below with reference to FIG. 2.

Also shown in FIG. 1 is a contactless payment card 104. In some embodiments, the contactless payment card may be entirely conventional, and of a type capable of interacting with a POS terminal without direct electrical contact. Thus the contactless payment card 104 may be referred to as a “contactless” payment card. As indicated at 106, and in accordance with further discussion below, the mobile device 102 and the contactless payment card 104 are shown as being in wireless, short-range radio data communication with each other. The contactless payment card may be one that implements either or both of chip based payments (such as MasterCard's M/Chip Advance) or contactless magnetic stripe transactions.

An optional component of the system 100 is a wallet service provider, represented by block 108 in FIG. 1. The wallet service provider, if present, may support set-up and operation of a digital wallet function in the mobile device 102.

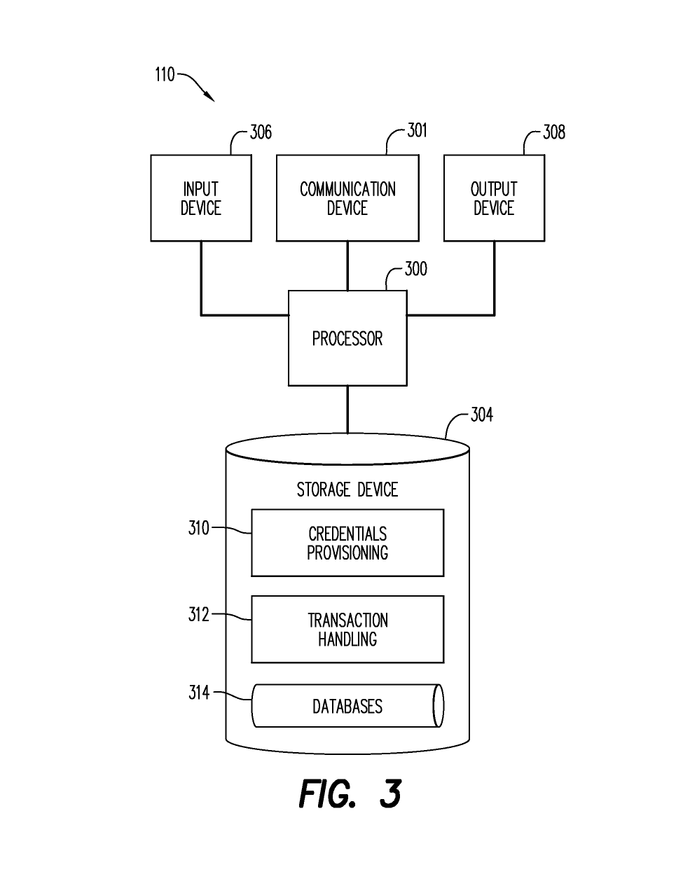

Also shown as part of the system 100 is a payment support service computer 110. Details of the payment support service computer 110 will be described below in connection with FIG. 3. The payment support service computer 110 may provide a number of support services to aid payment account issuers in operation of a payment account system. Provisioning of payment credentials to mobile devices on behalf of account issuers may be among the services provided by the payment support service computer 110. In some embodiments, the payment support service computer 110 may be operated by the operator of a payment network. One well-known payment network is operated by MasterCard International Incorporated, the assignee hereof It will be appreciated that the contactless payment card 104 and the mobile device 102 (once fully programmed and provisioned) may be configured to engage in payment account system transactions of the type handled by a payment network such as the one operated by the assignee hereof.

In some embodiments, the payment support service computer 110 may serve as a “Token Service Provider”, as that functional role is defined in the Tokenization Standard, referred to above. In other embodiments, the payment support service computer 110 may cooperatively interact with a Token Service Provider, which is not separately shown. As will be discussed further below, in some embodiments the payment credentials to be provisioned to the mobile device 102 from the payment support service computer 110 may include a “payment token” that stands in for a PAN (primary account number) in accordance with provisions of the Tokenization Standard. In other embodiments, the PAN may be part of the provisioned data.

Block 112 in FIG. 1 represents the issuer of the payment account that is to be digitized into the mobile device 102. It is noted that blocks 112 and 108 should both be considered to represent not only the indicated entity but also one or more computer systems operated by or on behalf of the respective entity.

Reference numeral 114 indicates communication facilities by which the mobile device is connected for purposes of data communication with one or more other components of the system 100. The communication facilities 114, for example, may include portions of a mobile communications network (not separately shown) for which the mobile device 102 is a subscriber device. Moreover, the communication facilities 114 may include portions of the Internet or other data networks (not separately shown) so that a data communication channel may be established between the mobile device 102 and the wallet service provider 108 and/or the payment support service computer 110.

A practical embodiment of the system 100 may include numerous instances of contactless payment cards and payment-enabled mobile devices, and also potentially a considerable number of account issuers. There may also be a number of wallet service providers and potentially more than one payment support service computer.

FIG. 2 is a block diagram that illustrates an example embodiment of the mobile device 102 shown in FIG. 1 and provided in accordance with aspects of the present invention. The mobile device 102 may be conventional in its hardware aspects. For example, the mobile device 102 may be a smartphone, and may resemble, in some or all of its hardware aspects and many of its functions, common commercially available smartphones. Alternatively, the mobile device 102 may be a tablet computer with mobile telecommunications capabilities. The ensuing description of the mobile device 102 is based on the assumption that it is embodied as a smartphone; those who are skilled in the art will readily understand from the following description how to embody the mobile device 102 as a tablet computer or other device apart from a smartphone.

The mobile device 102 may include a conventional housing (indicated by dashed line 202 in FIG. 2) that contains and/or supports the other components of the mobile device 102. The housing 202 may be shaped and sized to be held in a user's hand, and may for example exhibit the type of form factor that is common with the current generation of smartphones.

The mobile device 102 further includes conventional control circuitry 204, for controlling over-all operation of the mobile device 102. For example, the control circuitry 204 may include a conventional processor of the type designed to be the “brains” of a smartphone.

Other components of the mobile device 102, which are in communication with and/or controlled by the control circuitry 204, include: (a) one or more memory devices 206 (e.g., program and working memory, etc.); (b) a conventional SIM (subscriber identification module) card 208; (c) a conventional touchscreen 212 which serves as the primary input/output device for the mobile device 102, and which thus receives input information from the user and displays output information to the user. As is the case with many models of smartphones, in some embodiments the mobile device 102 may also include a few physically-actuatable switches/controls (not shown), such as an on/off/reset switch, a menu button, a “back” button, a volume control switch, etc. It may also be the case that the mobile device 102 includes a conventional digital camera, which is not shown.

The mobile device 102 also includes conventional receive/transmit circuitry 216 that is also in communication with and/or controlled by the control circuitry 204. The receive/transmit circuitry 216 is coupled to an antenna 218 and provides the communication channel(s) by which the mobile device 102 communicates via the mobile telephone communication network (which, e.g., is included in the above-mentioned communication facilities 114, FIG. 1).

Continuing to refer to FIG. 2, the receive/transmit circuitry 216 may operate both to receive and transmit voice signals, in addition to performing data communication functions. As is known to those who are skilled in the art, such data communication may be via HTTP (HyperText Transfer Protocol) or other communication protocol suitable for carrying out data communication over the internet.

The mobile device 102 further includes a conventional microphone 220, coupled to the receive/transmit circuitry 216. Of course, the microphone 220 is for receiving voice input from the user. In addition, a speaker 222 is included to provide sound output to the user, and is coupled to the receive/transmit circuitry 216.

The receive/transmit circuitry 216 may operate in a conventional fashion to transmit, via the antenna 218, voice signals generated by the microphone 220, and to reproduce, via the speaker 222, voice signals received via the antenna 218. The receive/transmit circuitry 216 may also handle transmission and reception of text messages and other data communications via the antenna 218.

The mobile device 102 may also include circuitry 224 that is partly or wholly dedicated to implementing NFC communications functionality of the mobile device 102. The mobile device 102 may further include a loop antenna 226, coupled to the NFC circuitry 224. In some embodiments, the NFC circuitry 224 may partially overlap with the control circuitry 204 for the mobile device 102. Moreover, the NFC circuitry 224 is associated with, and may also overlap with, a secure element 228 that is part of the mobile device 102 and is contained within the housing 202. The term “secure element” is well known to those who are skilled in the art, and typically refers to a device that may include a small processor and volatile and nonvolatile memory (not separately shown) that are secured from tampering and/or reprogramming by suitable measures. In some embodiments, the secure element 228 may be provided as part of the SIM card 208. In other embodiments, the secure element 228 may be constituted by an integrated circuit card separate from the SIM card 208 but possibly having the same form factor as the SIM card 208. In some embodiments of the mobile device 102, the secure element 228 may be conventional in its hardware aspects. In some embodiments, functionality as described below may be programmed into the secure element and/or other processing elements in the mobile device 102 in accordance with aspects of the present invention. (It should be noted that the term “secure element” is not intended to be limited to devices that are IC-based, but rather may also include any secure execution environment in a mobile device, and may include software based secure execution environments running on the main mobile device processor.) In some embodiments, the secure element 228 may be provisioned or pre-programmed with one or more payment application programs (“apps”) such that the mobile device is enabled to operate as a payment device vis-à-vis POS terminals. For this purpose, the mobile device 102 may communicate with the POS terminals via the antenna 226 in accordance with the NFC communication standard. Further, according to aspects of the present invention, the secure element 228 or other programmable component(s) of the mobile device 102 may be programmed such that the mobile device 102 is enabled to operate as a reader or terminal with respect to contactless payment cards. For this purpose, one or more of the payment apps may be suitably augmented with appropriate program instructions, or a separate app may be installed in the mobile device 102 to enable the reader/terminal functionality. In the case of either the augmented payment app or a dedicated reader/terminal app, the antenna 226 may be used by the app to engage in NFC communications with a contactless payment card according to processes described herein.

To summarize and elaborate on some of the foregoing, the mobile device 102 may have one or more of: (i) an embedded secure element; (ii) a SIM-based secure element; (iii) another form of securely storing payment applications and credentials, such as a micro SD card; (iv) support for cloud-based payments (e.g., for the functionality referred to as “HCE” in the Android environment; or as proposed in connection with the MasterCard Cloud Based Payments initiative put forward by the assignee hereof); (v) a trusted execution environment (TEE) for execution of payment-related applications. In addition or alternatively, other security related features may be utilized on the mobile device 102 in this regard, including security related features hereafter introduced.

It should also be understood that the mobile device 102 may be operable as a conventional mobile telephone for communication—both voice and data—over a conventional mobile telecommunications network, which is not depicted in the drawing apart from element 114 in FIG. 1. Thus, the mobile device 102 may be in communication from time to time in a conventional manner with a mobile network operator (“MNO”—not shown).

As is familiar to those who are skilled in the art, the mobile device 102 may be viewed as a small computing device. The mobile device 102 may include one or more processors that are programmed by software, apps and/or other processor-executable steps to provide functionality as described herein. The software, apps and/or other processor-executable steps may be stored in one or more computer-readable storage media (such as the storage devices 206 and/or the secure element 228) and may comprise program instructions, which may be referred to as computer readable program code means.

FIG. 3 is a block diagram that illustrates an example embodiment of the payment support service computer 110 shown in FIG. 1.

The payment support service computer 110 may be constituted by standard components in terms of its hardware and architecture but may be controlled by software to cause it to function as described herein. For example, the payment support service computer 110 may be constituted by server computer hardware.

The payment support service computer 110 may include a computer processor 300 operatively coupled to a communication device 301, a storage device 304, an input device 306 and an output device 308.

The computer processor 300 may be constituted by one or more processors. Processor 300 operates to execute processor-executable steps, contained in program instructions described below, so as to control the payment support service computer 110 to provide desired functionality.

Communication device 301 may be used to facilitate communication with, for example, other devices (such as a computer or computers operated by a wallet service provider or providers and/or account issuers and/or mobile devices such as the mobile device 102 shown in FIG. 1). For example (and continuing to refer to FIG. 3), communication device 301 may comprise numerous communication ports (not separately shown), to allow the payment support service computer 110 to communicate simultaneously with a number of other computers and other devices.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the payment support service computer 110, executed by the processor 300 to cause the payment support service computer 110 to function as described herein.

The programs may include one or more conventional operating systems (not shown) that control the processor 300 so as to manage and coordinate activities and sharing of resources in the payment support service computer 110, and to serve as a host for application programs (described below) that run on the payment support service computer 110.

The storage device 304 may store a credentials provisioning application program 310 that controls the processor 300 to enable the payment support service computer 110 to provide provisioning services by which payment accounts may be digitized into payment-enabled mobile devices, in accordance with aspects of the present invention.

Continuing to refer to FIG. 3, the programs stored in the storage device 304 may also include a transaction handling application program 312 that controls the processor 300 to enable the payment support service computer 110 to handle requests for payment transactions in a manner described herein.

The storage device 304 may also store, and the payment support service computer 110 may also execute, other programs, which are not shown. For example, such programs may include a reporting application, which may respond to requests from system administrators for reports on the activities performed by the payment support service computer 110. The other programs may also include, e.g., one or more data communication programs, database management programs, device drivers, etc.

The storage device 304 may also store one or more databases 314 required for operation of the payment support service computer 110.

An account issuer computer represented by block 112 in FIG. 1 may be similar in its hardware aspects and/or architecture to the computer hardware described above in connection with FIG. 3. However, the account issuer computer 112 may have different functions from the payment support service computer 110, and accordingly may run different programs from those of the payment support service computer 110.

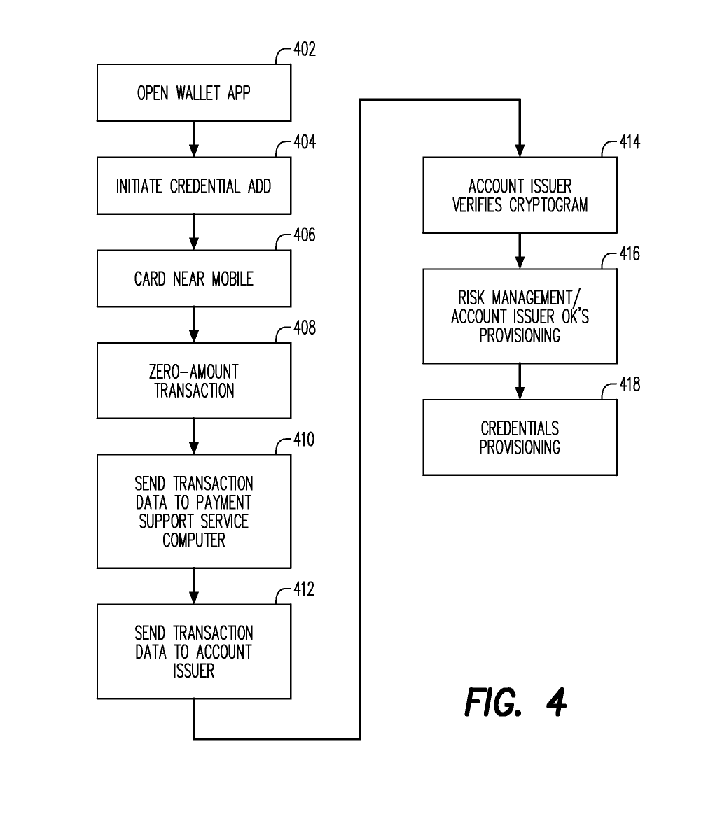

FIG. 4 is a flow chart that illustrates a process that may be performed in the system 100 shown in FIG. 1.

At 402, the user (not shown) may operate the mobile device 102 to open a wallet application program (“wallet app”) on the mobile device 102. At least in some embodiments, this may involve the wallet app requiring a user-authentication procedure to be successfully performed by the user. Possible types of user authentication may include biometric authentication (e.g., reading the user's fingerprint) or entry of a PIN required for access to the wallet app.

Assuming that user authentication, if required, was successfully completed, then, at the user's request, the wallet app may (as indicated by block 404) initiate an operation for provisioning payment credentials to the mobile device 102. The processing at block 404 may include establishing a communication channel between the mobile device 102 and the payment support service computer 110. In some embodiments, this communication channel may be constituted by routing communications between the mobile device 102 and the payment support service computer 110 via the wallet service provider 108 (if present). In some embodiments, the opening of the wallet app at block 402 may have caused the mobile device 102 to have contacted the wallet service provider 108. In addition or alternatively, data communications may be exchanged directly between the mobile device 102 and the payment support service computer 110. (When data is said to be transmitted or received by the payment support service computer 110 to or from the mobile device 102, this includes direct or indirect transfers of data.)

At block 406 in FIG. 4, the user may bring the contactless payment card 104 into proximity with the mobile device 102. The user may do so in response to a prompt provided on the touchscreen 212 of the mobile device 102. This may occur in such a manner that the contactless payment card 104 and the mobile device 102 are enabled/triggered to engage in short-range radio communication with each other. For example, the user may be prompted to tap the contactless payment card 104 on the mobile device 102 at a location on the mobile device 102 that is adjacent to the NFC antenna 226 (FIG. 2). The mobile device 102, acting in a reader or terminal mode of operation, may transmit an interrogation signal to which the contactless payment card 104 may respond, thereby resulting in a data communications “handshake” between the mobile device 102 and the contactless payment card 104.

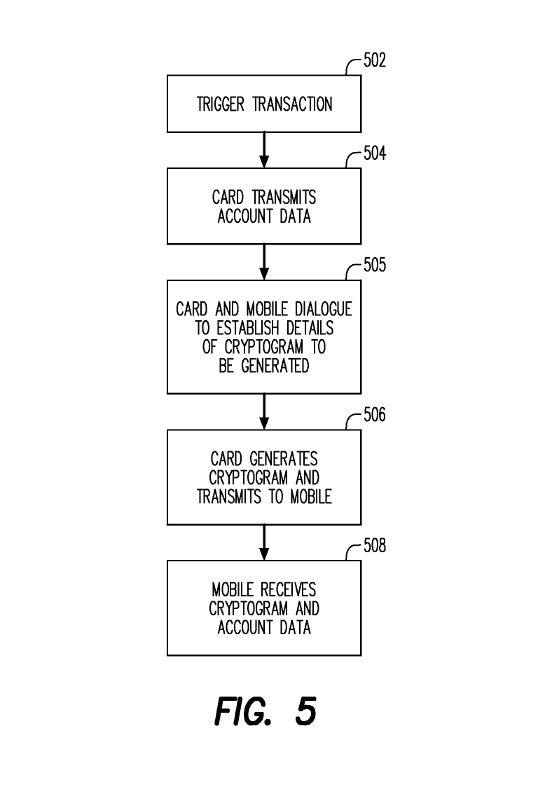

At block 408, according to some embodiments, the mobile device 102 and the contactless payment card 104 may interact with each other such that a “zero-amount” payment account transaction is performed by the two devices. The transaction does not necessarily need to be for a zero amount, but if such a transaction is employed, a skilled artisan familiar with the concepts of EMV will recognize that a zero amount transaction is less likely to cause declines at a card level, and is more likely to succeed—however conceptually the amount could be any value. Such a transaction, as is understood by those who are skilled in the art, may entail exchanging of data communications between the contactless payment card 104 and the mobile device 102. FIG. 5 is a flow chart that illustrates aspects of the zero-amount transaction represented by block 408.

Referring to FIG. 5, at block 502 the transaction may be triggered, by, e.g., a suitable command or message from the mobile device 102 (functioning as a reader or terminal) to the contactless payment card 104. At block 504, the contactless payment card 104 may transmit account data. At block 505, the contactless payment card 104 and the mobile device 102 may engage in a dialog/exchange of messages to establish details concerning the cryptogram to be generated. At block 506, the contactless payment card 104 may engage in an EMV transaction or the like with the mobile device 102, such that the contactless payment card 104 may generate a cryptogram and transmit it to the mobile device 102. Other types of transaction processes may alternatively be performed to cryptographically authenticate the contactless payment card 104.

In some embodiments, for example, the zero-amount transaction may be performed in accordance with the well-known EMV standard for payment account transactions at the point of sale. In such a case, the contactless payment card 104 may generate and transmit the type of cryptogram normally required of the payment device in an EMV transaction. In other embodiments, the transaction may be performed in accordance with a practice in which a contactless payment card 104 emulates “magnetic stripe” style transactions. In the latter type of embodiment, the contactless payment card 104 may generate a dynamic security code (e.g., the type of code known as a “dCVC3”; or a similar type of security code). As is familiar to those who are skilled in the art, in generating the dynamic security code, the contactless payment card 104 may perform a cryptographic process to produce a result that is then truncated to three or four digits, with the truncated result serving as the dynamic security code. The term “cryptogram” should be understood to include such a cryptographically generated dynamic security code.

In some embodiments, the transaction need not be a zero-amount transaction.

In the zero-amount transaction represented by block 408, the contactless payment card 104 may also transmit, to the mobile device 102, payment credential data that has been stored in the contactless payment card 104. This payment credential data may include a PAN or payment token associated with the payment account to be digitized into the mobile device 102. The payment credential data may also include other data, such as an expiration date for the payment account in question. In many cases, the payment credential data will include a PAN rather than a payment token. It will also be appreciated that, as part of the zero-amount transaction (and as represented at block 508 in FIG. 5), the mobile device 102 may receive the cryptogram generated and transmitted by the contactless payment card 104, and may also receive the payment credential data transmitted by the contactless payment card 104 and as such should treat them securely.

In some embodiments, the interaction between the contactless payment card 104 and the mobile device 102 may be different from a zero-amount transaction or other point-of-sale style transaction. For example, without following the standard process of a payment account transaction, the contactless payment card 104 may generate a cryptogram according to a predetermined process. The contactless payment card may pass the cryptogram and a PAN (or other account indicator) to the mobile device by an exchange of data that does not emulate a payment account transaction.

As used herein and in the appended claims, “cryptogram” should be understood to include any result or outcome of a cryptographic process, including truncated or modified results of such processes.

Referring again to FIG. 4, at block 410 the mobile device 102 may transmit—to the payment support service computer—directly or indirectly—some or all of the data received by the mobile device 102 from the contactless payment card 104 as part of the zero-amount transaction of block 408. The data transmitted at 410 by the mobile device 102 may include the above-mentioned cryptogram/dynamic security code and the PAN (or other account indicator) received by the mobile device 102 from the contactless payment card 104. In some embodiments, the data transmitted from the mobile device 102 may be formatted as a payment account transaction authorization message. In some embodiments, the data transmitted from the mobile device 102 may include data that uniquely identifies the mobile device 102. In view of the direct or indirect data communication channel established between the mobile device 102 and the payment support service computer 110, the payment support service computer 110 may receive the data transmitted by the mobile device 102 at block 410.

At block 412, the payment support service computer 110 may transmit at least some of the transaction data to the account issuer 112, with an indication that the payment support service computer 110 is seeking consent from the account issuer 112 to provision payment credentials to the mobile device 102 with respect to the payment account represented by the transaction data. (It should be understood that the payment support service computer 110 may have identified which account issuer to contact based on the account indicator it received from the mobile device 102.) The transaction data transmitted by the payment support service computer 412 at block 412 may include, for example, the cryptogram generated by the contactless payment card 104 and the PAN or other account indicator read by the mobile device 102 from the contactless payment card 104 at 408. It will be appreciated that the account issuer 112 may receive the data transmitted to it by the payment support service computer 110 at block 412.

At block 414, the account issuer 112 may verify the cryptogram it received from the payment support service computer 110. For example, the account issuer may perform a conventional process by which cryptograms or dynamic security codes (as the case may be) are verified by account issuers in connection with payment account transactions. The account issuer 112 may verify other information received from the payment support service computer 110, such as the validity of the PAN or account indicator received from the payment support service computer 110. The account issuer may also verify that the payment account in question is in good standing.

At block 416, the account issuer 112 may engage in a risk management/evaluation process with respect to the provisioning request received from the payment support service computer 110. In some embodiments and/or in some instances, the account issuer 112 may simply consent to the request (e.g., in response to verifying the cryptogram) and may send a message to that effect to the payment support service computer 110. In other embodiments or instances, e.g., as a result of the outcome of the risk management process, the account issuer 112 may determine that an ID&V (identification and verification) process should be performed. The account issuer 112 may then perform the ID&V process (in a manner that is familiar to those who are skilled in the art), and assuming that the process has a satisfactory outcome, the account issuer 112 may then consent to the provisioning request. In some instances, e.g., when the ID&V process fails, the account issuer 112 may decline to consent to the provisioning request. In such a case, the provisioning may not go ahead.

In addition or alternatively to a provisioning operation dependent on successful authentication of the contactless payment card via a channel through the mobile device, the system may take another action that reflects successful authentication of the contactless payment card. For example, a process similar to that of FIG. 4 could be employed as part of a two-factor security scheme in connection with an e-commerce purchase transaction.

For example, reference was made above to “in app” transactions initiated from within a merchant's e-commerce application. For such a transaction, the customer's mobile device may be suitably programmed to interact with the merchant's e-commerce server computer to aid in authenticating the customer and confirming that the customer is in possession of a valid payment card. Thus, a card authentication process may be performed as described herein, with the customer's mobile device programmed and equipped to interact with the customer's payment card to elicit a cryptogram from the payment card and to pass the cryptogram to the merchant's e-commerce application for forwarding on to the card issuer for validation of the cryptogram. With these security aspects successfully accomplished, the e-commerce transaction may go forward with a high degree of confidence that the customer is in possession of a valid payment card that corresponds to the payment information used for the e-commerce transaction.

Assuming that the account issuer 112 has consented to the provisioning request from the payment support service computer 110, then block 418 may follow block 416. At block 418, the payment support service computer 110 may provision payment credentials to the mobile device 102. In some embodiments, the provisioning may occur in the same manner as if the account information had been obtained by manual input or account information or photographic reading of account information at the mobile device 102. The payment credentials provisioned to the mobile device 102 may be the same as or different from the payment credentials embodied in the payment card 104, although it will generally be the case that the payment credentials provisioned to the mobile device 102 provide access to the same payment account that is accessible via the payment card 104. The payment credentials provisioned to the mobile device 102 may in some cases include a PAN and in other cases may include a “payment token” as that term is used in the tokenization standard. The payment credentials provisioned to the mobile device 102 may include some or all of the other information (e.g., account and/or token expiration date, account holder's name, cryptographic key, etc.) commonly loaded into a payment card during personalization of the card.

It will be appreciated that, notwithstanding interim steps, the provisioning of the payment credentials from the payment support service computer 110 to the mobile device 102 is in response to the payment support service computer receiving the cryptogram and/or the account data from the mobile device 102.

It may be said that the payment credentials provisioned to the mobile device 102 at block 418 may “match” the credentials stored in the contactless payment card 104 in the sense that both sets of credentials provide access to the same payment account owned by the user of the contactless payment card 104 and the mobile device 102. In one example, which is among a number of different possibilities, the contactless payment card 104 may store the PAN for the payment account, while the credentials provisioned to the mobile device 102 include a payment token that stands in for that PAN. It will be appreciated that in some use-cases, the credentials provisioned to the mobile device may include the same PAN stored in the contactless payment card

In some embodiments, the provisioning of the payment credentials may include storing a PAN or payment token and related data in the secure element 228 (FIG. 2) in the mobile device 102. In other embodiments (e.g., where the mobile device does not include a hardware-based secure element), the provisioning of the payment credentials may include storing a PAN or payment token and related data in a secure remote host server (not shown) that provides remote emulation of a secure element. In such cases, the data provisioned to the secure remote host server may be accessible by a secure execution environment on the mobile device as needed for the mobile device to engage in a payment account transaction at the point of sale. In general, the provisioning step may involve some or all of the types of security features of a mobile device, as described above in conjunction with FIG. 2.

The process of FIG. 4 may be advantageous in that it offers a high degree of convenience to the user, along with a reduction in opportunities for errors in conveying account information to the payment support service computer. Moreover, because the process involves generation of a cryptogram by the contactless payment card, with verification of the cryptogram by the account issuer, security of the provisioning process is improved. In particular, there is a high degree of likelihood with this process that the user who is initiating the digitization of the payment account is in possession of a valid contactless payment card that represents the account.

Still further, the process of FIG. 4 allows digitization of the payment account to be accomplished even when the user's contactless payment card lacks any visible representation of an account number.

In embodiments that have been described above, a contactless payment card (i.e., a card-shaped object), was used to provide the cryptogram (and account data) to the mobile device. Alternatively, however, a payment device that is not card-shaped may be used in place of the contactless payment card. Examples of other types of payment devices that may be used in this role include payment wristbands, watches, fobs, etc. It should also be understood that the term “payment device” includes contactless payment cards.

The technique described above for payment device authentication may be advantageous for use in connection with any type of procedure that requires or would benefit from remote reading of the payment device.

As used herein and in the appended claims, the term “account indicator” should be understood to include both PANs and payment tokens.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable.

As used herein and in the appended claims, the term “payment system account” includes a credit card account or a deposit account that the account holder may access using a debit card. The terms “payment system account”, “payment account” and “payment card account” are used interchangeably herein. The term “payment account number” includes a number that identifies a payment system account or a number carried by a payment card, or a number that is used to route a transaction in a payment system that handles debit card and/or credit card transactions. The term “payment card” includes a credit card, a debit card or a pre-paid card.

As used herein and in the appended claims, the term “payment system” refers to a system for handling purchase transactions and related transactions. An example of such a system is the one operated by MasterCard International Incorporated, the assignee of the present disclosure. In some embodiments, the term “payment system” may be limited to systems in which member financial institutions issue payment accounts to individuals, businesses and/or other organizations.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
establishing a communication channel between a mobile device and a remote payment support service computer;
bringing a contactless integrated circuit (IC) payment card into proximity with the mobile device;
exchanging data communications between the contactless IC payment device and the mobile device;
generating a cryptogram in the contactless IC payment device;
transmitting the cryptogram from the contactless IC payment device to the mobile device;
receiving the cryptogram in the mobile device; and
transmitting the cryptogram from the mobile device to the remote payment support service computer.

2. The method of claim 1, further comprising:
responding in the payment support service computer to receiving the cryptogram by provisioning payment credentials from the payment support service computer to the mobile device.

3. The method of claim 1, wherein the mobile device is a device selected from the group consisting of: (a) a smartphone; (b) a tablet computer; (c) a personal computer; and (d) a smart watch.

4. The method of claim 1, wherein the contactless IC payment device is a card-shaped object.

5. The method of claim 4 wherein the contactless IC payment device is a device selected from the group consisting of: (a) a contactless payment card; and (b) a device that complies with a standard that governs contactless payment cards.

6. The method of claim 1, wherein the payment credentials are associated with a payment account owned by a user of the mobile device.

7. The method of claim 6, wherein the payment account is accessible by presenting the contactless IC payment device at a point of sale.

8. The method of claim 1, wherein the exchange of data communications between the contactless IC payment device and the mobile device comprises a zero-amount payment card account transaction.

9. The method of claim 1, wherein the exchange of data communication between the contactless IC payment device and the mobile device comprises a transaction other than a zero-amount transaction.

10. The method of claim 8, wherein the exchange of data communication between the contactless IC payment device and the mobile device is performed in accordance with the NFC communication standard.

11. The method of claim 1, wherein the contactless IC payment device lacks any visible representation of an account indicator digitally stored in the contactless IC payment device.

12. The method of claim 1, further comprising:
responding in the payment support service computer to receiving the cryptogram by approving an e-commerce purchase transaction.

13. A mobile device, comprising:
a processor; and
a memory in communication with the processor, the memory storing program instructions, the processor operative with the program instructions to perform functions as follows:
establishing a communication channel with a remote payment support service computer;
exchanging data communications with a contactless integrated circuit (IC) payment device;
triggering the contactless IC payment device to generate a cryptogram;
receiving the cryptogram from the contactless IC payment device; and
transmitting the received cryptogram to the remote payment support service computer.

14. The mobile device of claim 13, wherein the processor is further operative with the program instructions to perform a function of:
receiving provisioning of payment credentials from the remote payment support service computer.

15. The mobile device of claim 13, wherein:
the payment credentials provisioned to the mobile device match payment credentials and/or a token stored in the contactless IC payment device.

16. The mobile device of claim 13, wherein the data communications exchanged with the contactless IC payment device comprise a zero-amount payment card account transaction.

17. The mobile device of claim 13, wherein the data communications exchanged with the contactless IC payment device comprise a transaction that is not a zero-amount transaction.

18. The mobile device of claim 13, wherein the processor is further operative with the program instructions to:
receive an account indicator from the contactless IC payment device; and
transmit the received account indicator to the remote payment support service computer.

19. The mobile device of claim 18, wherein the account indicator is a primary account number (PAN) that identifies a payment account accessible via the contactless IC payment device.

20. A method comprising:
establishing a communication channel with a mobile device;
receiving a cryptogram from the mobile device, the cryptogram relayed by the mobile device from a contactless integrated circuit (IC) payment device that interacted with the mobile device; and
in response to receiving and validating the cryptogram, authenticating the contactless IC payment device.

21. The method of claim 20, further comprising:
provisioning payment credentials to the mobile device in response to authenticating the contactless IC payment device.

22. The method of claim 21, further comprising:
prior to said provisioning step, obtaining consent for said provisioning step from an issuer of the contactless IC payment device.

23. The method of claim 22, further comprising:
receiving an account indicator from the mobile device, the account indicator relayed by the mobile device from the contactless IC payment device;
and wherein said obtaining consent includes transmitting the account indicator and the cryptogram to the issuer of the contactless IC payment device.

24. The method of claim 23, wherein:
the account indicator is a PAN (primary account number) that identifies a payment account owned by a user of the mobile device; and
said payment credentials provisioned to the mobile device include one of: (a) said PAN; and (b) a payment token associated with said PAN.
